(19) United States
(12) Patent Application Publication
(10) Pub. No.: US 2026/0183996 A1
(43) Pub. Date: Jul. 2, 2026

(54) TANK MANUFACTURING BY OVERMOLDING A COMPOSITE INSERT

(71) Applicant: Faurecia Hydrogen Solutions France, NANTERRE (FR)

(72) Inventors: Pierre-Alexandre ROBERT, BAVANS (FR); Eric OTTAVIANI, BAVANS (FR); Gaëtan RICHARD, BAVANS (FR); Christophe BAVEREL, BAVEREL (FR); Thomas FERRIER, BAVEREL (FR)

(21) Appl. No.: 19/428,533

(22) Filed: Dec. 22, 2025

(30) Foreign Application Priority Data
Dec. 31, 2024 (FR) 24 15438

(51) Int. Cl. B29C 45/14; B29C 45/00; B29C 45/72; B29K 101/12; B29L 31/00

(52) U.S. Cl. CPC B29C 45/14008; B29C 45/0001; B29C 45/7207; B29C 2045/14868; B29K 2023/06; B29K 2101/12; B29L 2031/712

(57) ABSTRACT

A method for manufacturing a tank for pressurized gas includes producing a composite insert comprising a fiber reinforcement embedded in a thermoset matrix, placing the composite insert in a mold, and overmolding, over at least part of a surface of the composite insert, with an overmolding polymer. The method further includes cooling/curing, and further comprising, between the producing step and the overmolding step, a step of depositing a bonding polymer on at least part of the surface of the composite insert.

### CROSS-REFERENCE TO RELATED APPLICATION

This application is a U.S. non-provisional application claiming the benefit of French Application No. 24 15438, filed on Dec. 31, 2024, which is incorporated herein by reference in its entirety.

### TECHNICAL FIELD

The disclosure relates to a method for manufacturing a tank by overmolding a composite insert and to such a tank.

### BACKGROUND

It is a known practice to manufacture a tank or tank part by overmolding a composite insert.

Such a method comprises the following steps. In a first step, a composite insert is produced. This insert conventionally comprises a fiber reinforcement embedded in a thermoset matrix. Once produced, this insert is placed in a mold. Said mold is suitable for the injection of an overmolding polymer. In an overmolding step, the overmolding polymer is injected into the mold, at least partially, around the insert. The assembly is then cooled in order to cure the overmolding polymer and obtain the tank part.

Due to the different materials used between the overmolding polymer and the composite material of the insert, differential shrinkage may occur between the insert and the overmolding during cooling. This differential shrinkage can lead to a gap between the insert and overmolding, resulting in a lack of material and a lack of adhesion between the insert and overmolding.

Thus, there is a desire to find a manufacturing method that corrects this drawback, so as to avoid such a gap and ensure adhesion between the insert and overmolding.

### SUMMARY

The disclosure aims to correct these drawbacks by preventing the formation of gaps caused by differential shrinkage.

To this end, the disclosure relates to a method for manufacturing a tank for pressurized gas, such as hydrogen, the method comprising the following steps:
producing a composite insert comprising a fiber reinforcement embedded in a thermoset matrix;
placing said composite insert in a mold;
overmolding, over at least part of a surface of the composite insert, with an overmolding polymer;
cooling/curing;
and further comprising, between the producing step and the overmolding step, a step of:
depositing a bonding polymer on at least part of the surface of the composite insert.

Particular features or embodiments, usable alone or in combination, are:
the bonding polymer is deposited by powder coating on a preheated composite insert,
the method further comprises, between the depositing step and the overmolding step, a step of cooling/curing the bonding polymer,
the bonding polymer is preferentially deposited in at least one differential shrinkage zone,
said at least one differential shrinkage zone, an amount and distribution of bonding polymer are determined by analyzing a shape of the part/mold or by analyzing a scrap part produced without bonding polymer,
the bonding polymer is deposited in the concave zones of the insert,
the bonding polymer is a polyethylene-based polymer,
the overmolding polymer is a thermoplastic polymer,
the fiber reinforcement comprises glass or carbon fibers and the thermoset matrix is an epoxy resin.

According to another aspect, a tank for pressurized gas, such as hydrogen, produced by such a method.

According to another aspect, a tank for pressurized gas, such as hydrogen, comprising a composite insert, comprising a fiber reinforcement embedded in a thermoset matrix, and an overmolding covering at least part of the surface of the insert with an overmolding polymer, wherein at least part of the surface of the insert comprises a deposit of a bonding polymer.

### BRIEF DESCRIPTION OF THE DRAWINGS

The disclosure will be better understood on reading the following description, given solely by way of example, and with reference to the appended figures in which:

FIG. 1 shows an insert for a gas tank in perspective view;

FIG. 2 shows, in perspective view, an insert overmolded according to the prior art; and

FIG. 3 shows, in perspective view, an insert overmolded according to the disclosure.

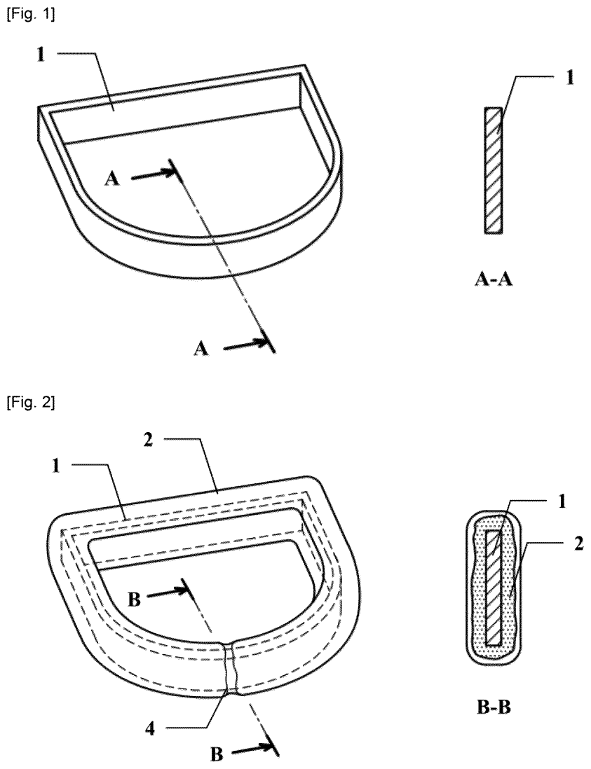

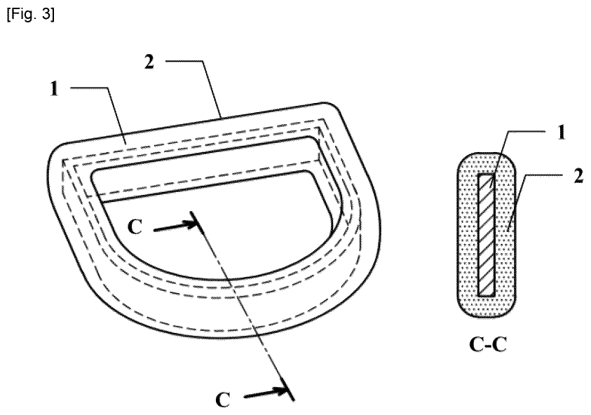

### DESCRIPTION OF THE EMBODIMENTS

The disclosure relates to a method for manufacturing a tank for pressurized gas, such as hydrogen. This method comprises the following steps, described above.

In a first step, a composite insert 1 is produced. This insert 1 conventionally comprises a fiber reinforcement embedded in a thermoset matrix. Once produced, this insert 1 is placed in a mold. Said mold is suitable for the injection of an overmolding polymer 2. In an overmolding step, an overmolding polymer 2 is injected into the mold, in contact with at least part of the surface of the insert 1. In a final step, the assembly is then cooled in order to cure it and obtain the part, part of a tank.

According to one feature, the method further comprises a step of depositing a bonding polymer. This is deposited in contact with at least part of the surface of the insert 1. This step takes place between the production step and the overmolding step. This step can be carried out before or after the insert 1 is placed in the mold.

The purpose of depositing this bonding polymer is twofold. A first purpose of the bonding polymer is to ensure bonding of the overmolding polymer 2 to the composite insert 1. A second purpose of the bonding polymer is to provide an intermediate material to compensate for the lack of material caused by differential shrinkage.

According to another feature, the bonding polymer is deposited by hot powder coating. The bonding polymer is thus in powder form. This powder is sprinkled over at least part of the surface of the insert 1. To heat said powder, the insert 1 is preheated.

According to another feature, the method further comprises a cooling step. This cooling step allows the bonding polymer to cure. This step occurs between the deposition step, in which the bonding polymer is introduced, and the overmolding step, in which the overmolding polymer 2 is injected.

The bonding polymer can thus be cooled before overmolding. Overmolding, which injects a hot overmolding polymer 2, leads to further softening of the bonding polymer. This softening helps to improve the adhesion of the overmolding polymer 2 to the bonding polymer and thus to the composite insert 1 to which the bonding polymer is bonded.

In order to better address the problem of differential shrinkage, a further feature is that the bonding polymer is deposited, as a priority, in at least one differential shrinkage zone 4. In this way, the material supplied by the bonding polymer is arranged where adhesion is most needed, and where there is the greatest lack of material, in order to fill the gap.

According to another feature, said at least one differential shrinkage zone 4 is determined by analyzing the shape of the part, or equivalently by analyzing the shape of the mold.

By analyzing this shape, a person skilled in the art can predict the location and dimensions of the shrinkage that will occur. A differential shrinkage zone 4 is therefore to be expected in the curved zones at the ends. Similarly, the one or more inner faces, i.e. the concave zones of the insert 1, are candidates. The dimensions of the differential shrinkage can also be used to determine the quantity and distribution of bonding polymer required to compensate for said differential shrinkage.

Alternatively or additionally, this can be determined empirically, by manufacturing a part without using a bonding polymer, i.e. according to the prior art. This results in a scrap part with one or more differential shrinkage zones 4. Analyzing these differential shrinkage zones 4 indicates the positions and dimensions of the one or more differential shrinkage zones 4 and consequently makes it possible to determine the quantities and distributions of bonding polymer required to compensate therefor.

Generally speaking, differential shrinkage zones 4 appear mainly in the concave parts of the insert 1.

Fine-tuning the quantities and locations of the bonding polymer deposits may require trial and error.

According to another feature, the bonding polymer is a polyethylene-based polymer. This material has adhesion characteristics that allow adhesion to be achieved between the insert 1 and the overmolding polymer 2. This material also makes it possible to have stretch characteristics compatible with the tension that occurs in place of potential differential shrinkage, so that none is produced.

According to another feature, the material of the overmolding polymer 2 remains that dictated by the needs of the part. Thus, it may also be a polyamide, such as PA 6, PA 11 or PA 12. Alternatively, it may be a polyethylene, which advantageously affords better cohesion with the bonding polymer. Alternatively, other thermoplastic polymers can be used.

According to another feature, the insert 1 is made of composite. This composite is reinforced with fibers. These fibers can be glass or carbon fibers, preferably carbon. This reinforcement is embedded in a thermoset matrix. This thermoset matrix is advantageously made of epoxy resin. Other thermoset materials can also be used.

The disclosure also relates to a tank or tank part produced by the method as described above.

The disclosure also relates to a tank comprising a composite insert 1 and an overmolding. The insert 1 comprises a fiber reinforcement embedded in a thermoset matrix. The overmolding covers at least part of the surface of the insert with an overmolding polymer 2. According to one feature, at least part of the surface of the insert 1 is covered with a deposit of a bonding polymer.

The disclosure has been illustrated and described in detail in the drawings and the preceding description. This must be considered as illustrative and given by way of example and not as limiting the disclosure to this description alone. Many alternative embodiments are possible.

### LIST OF REFERENCE SIGNS

1: insert,
2: overmolding polymer,
4: differential shrinkage zone.

1. A method for manufacturing a tank for pressurized gas, the method comprising the following steps:
producing a composite insert comprising a fiber reinforcement embedded in a thermoset matrix;
placing the composite insert in a mold;
overmolding, over at least part of a surface of the composite insert, with an overmolding polymer;
cooling and curing;
wherein the method further comprises, between the producing step and the overmolding step, a step of:
depositing a bonding polymer on at least part of the surface of the composite insert.

2. The method as claimed in claim 1, including preheating the composite insert to provide a preheated insert, wherein the bonding polymer is deposited by powder coating on the preheated insert.

3. The method of claim 1, further comprising, between the depositing step and the overmolding step, a step of cooling and curing the bonding polymer.

4. The method of claim 1, wherein the bonding polymer is deposited in at least one differential shrinkage zone.

5. The method as claimed in claim 4, wherein in the at least one differential shrinkage zone, an amount and distribution of bonding polymer are determined by analyzing a shape of part of the tank produced in the mold or of the mold or by analyzing a scrap part produced without bonding polymer.

6. The method of claim 1, wherein the bonding polymer is deposited in concave zones of the composite insert.

7. The method of claim 1, wherein the bonding polymer is a polyethylene-based polymer.

8. The method of claim 1, wherein the overmolding polymer is a thermoplastic polymer.

9. The method of claim 1, wherein the fiber reinforcement comprises glass or carbon fibers and wherein the thermoset matrix is an epoxy resin.

10. A tank for pressurized gas produced by the method as claimed in claim 1.

11. A tank for pressurized gas comprising:
a composite insert comprising a fiber reinforcement embedded in a thermoset matrix; and
an overmolding covering at least part of a surface of the composite insert with an overmolding polymer, wherein at least part of the surface of the composite insert comprises a deposit of a bonding polymer.

12. The method of claim 1, wherein the pressurized gas is hydrogen.
